(19) United States
(12) Patent Application Publication
(10) Pub. No.: US 2002/0091483 A1
(43) Pub. Date: Jul. 11, 2002

(54) Procedure and system for an automatically locating and surveillance of the position of at least one track-guided vehicle

(76) Inventor: Bernard Douet, Neusiedl am See (AT)

Correspondence Address: Andrew F. Reish, DAVID, BRODY & DONDERSHINE, LLP, Suite 202, 8221 Old Courthouse Road, Vienna, VA, 22182, US

(21) Appl. No.: 09/988,508

(22) Filed: Nov. 20, 2001

(30) Foreign Application Priority Data
May 25, 1999 (AT) AT 929/99
May 24, 2000 (AT) PCT/AT00/0144

(51) Int. Cl. G06G 7/78; G06F 17/10

(52) U.S. Cl. 701/207; 701/301

(57) ABSTRACT

The invention relates to a method and a system for automatically detecting or monitoring the position of at least one guided vehicle (22), in particular, a railborne vehicle, and for emitting warning signals. According to the invention, the position of the vehicle (22) is preferably detected and monitored continuously in said vehicle by means of relayed information and transmitter/receiver devices (18, 19) which are located in the area of the tracks or rails (21) on which the vehicle is guided. According to the invention, if dangerous situations arise, the vehicle (22) emits warning signals, at least to other vehicles (22) which are in the immediate vicinity, in particular, to vehicles which are traveling on different routes from the one being covered by the first vehicle, in order to achieve increased reliability and safety in the case of malfunctions.

### I)

The present invention concerns a procedure for the automatically locating and monitoring the position of at least one track-guided vehicle, especially rail-vehicle, and for the emission of warning signals, whereby within the vehicle, preferably the position of the vehicle will be continuously located and surveyed whereby within the vehicle, the position of the vehicle will be, preferably continuously, located and surveyed by the means of a combination of transmission devices, respectively transmitter—receiver units, which are arranged in the zone near the tracking respectively the rails, the resulting data in connection with the driven distance resulting data will be compared with a predetermined and previously given data concerning the vehicle-move on an indicated distance.

### II)

The present invention concerns also a system for the automatically locating and monitoring the position of at least one track-guided vehicle, especially rail-vehicle, and for the emission of warning signals, whereby within the vehicle, preferably the position of the vehicle will be continuously located and surveyed whereby within the vehicle, the position of the vehicle will be, preferably continuously, located and surveyed by the means of a combination of transmission devices, respectively transmitter—receiver units, which are arranged in the zone near the tracking respectively the rails, the resulting data in connection with the driven distance resulting data will be compared with a predetermined and previously given data concerning the vehicle-move on an indicated distance.

There are already different systems known in connection with the problematic of locating, respectively the surveillance of the position of at least one track guided vehicle, especially a trail-vehicle and for emission of warning signals.

For instance it is already known that each rail-vehicle is connected at least with one control and guiding station by the means of an adequate control- and signal transmission system, especially radio-system, whereby the controlling and surveillance of many other rail-vehicles which are situated in a certain limited region, will be done through this above mentioned control and guiding station. In connection with this matter it can be referred to the DD-B 292 880, the U.S. Pat. Nos. 5,129,605, the 4,711,418, the WO 93/15946, the DE-A 43 31 931 and the DE-A 41 23 632.

Furthermore it is already known that rail-vehicles, also other vehicles in general are controlled by the means of surveillance satellites, whereby in connection with this matter it can be referred for example to the DE-A 42 44 624. Disadvantage in this kind of systems and procedures is, that in particular the surveillance, respectively each signal transmission had to be accomplished through a control and guiding station or alike, consequently if a defect or an error take place in the above mentioned guiding and control station, respectively if an error or fault in the controlling system or in the transmission of data between the control and guiding station and the individual rail-vehicle, respectively vehicles, have a negative influence on the procedure, so the required security and reliability of the locating and surveillance systems, cannot be guarantied any more. Another disadvantage of such known methods for controlling through satellites is, that a certain positioning-deviation through satellites, which is deliberately done by the satellites management. A reliable and accurate position of the rail-vehicle can be obtained in this case, by the elimination of this deviation which can be accomplished only by the deployment of additionally expensive and complicated equipments; furthermore and according to topographical reasons it may come to unsatisfactory data reception from four satellites at the time, which is very important for the required conditions to obtain a perfect positioning whereby in some regions or for example in tunnels, the receptions from satellite will be partially or totally disturbed. In connection with the satellites positioning systems it is obvious that a high performance transmitting and reception units are needed, which are capable of dispatching the signals to another far control respectively guiding station.

The DE-A 197 15 773 describes another procedure for securing the operational guiding system of a rail-vehicle by the use of safety devices, in which the locating is once again realized through satellite locating system, whereby a great amount of information concerning the position etc. is accomplished through different safety devices, from which some of them are stationary and others are installed in another rail-vehicle.

A procedure as well as a system like the sort of the mentioned in the beginning is e.g. as you can see in the U.S. Pat. No. 5,364,074, the EP-A 0 479 529 or the WO 94/05536, whereby it is tried, to trace the position of a vehicle with the help of transmitter-receiver-units along the route and to compare with the data related to distance. Furthermore in these known types special data are transmitted to a control station, which can transmit the data related to the train to further rail-vehicles.

The present invention is aiming at the creation of a procedure as well as at a system to locate and survey the position of at least one track-guided vehicle, especially a rail-vehicle, and at the emission of warning signals, with which the reliability and security of availability can be enormously increased, whereby especially mistakes in the control station respectively problems of an information exchange between one vehicle and such a control station not immediate lead to a eventually complete falling out of the system and combined with this to security-risks.

In order to solve these targets, the present invention for automatically locating respectively monitoring the position of at least one track-guided vehicle, especially of a rail-vehicle, and for the emission of warning signals of that kind mentioned in the beginning is essentially characterised through that, that merely when dangerous situations arise, the vehicle sends warning signals at least to other vehicles being in the local close zone, especially to other vehicles which use another distance than the immediate practicable distance. As in the vehicle, preferably continuously, the position of the vehicle is located and surveyed and also compared with the previously given data, can the accordance of the determined and acquired data, e.g. the position, the speed, the time and the like be surveyed immediate in the vehicle by a determined distance without engaging a control station and resultantly immediate in the vehicle can be recognised, if differences to a previously given distance or the like occur.

Also other track-guided will be regarded as vehicles in the present invention beside the usual rail-vehicles vehicles, e.g. as robot-directed vehicles in warehouses or the like, which e.g. are directed along from tracks in the floor or the like and emit electromagnetic signals. Alternatively it goes without saying, that vehicles being directed via other control systems are also included, which move alongside of determined tracks, whereas crossings result similar to those like with such general, track-guided vehicles. These crossings must be separately controlled by the use of such eventual fully automatic driven respectively directed vehicles.

According to invention it is furthermore foreseen, that the vehicle can send warning signals at least to other vehicles being in the local close zone whenever dangerous situations respectively divergence from a determined track, occur, so that a essential element of this invention is, that a direct communication between vehicles lying or plying in the local close zone is possible, without absolutely inserting a higher ranking control station.

Vis a vis the types of the known state of the art, through this possibility of direct communication between vehicles being in the local close zone not only that the transfer time of the data, which indicate a dangerous situation, is reduced respectively with the transfer of warning signals, but it is also possible to avoid respectively to enormously minimise additional safety risks, which eventually arise by mistake in a control station. According to invention it is possible to transfer the message of dangerous situations respectively warning signals also to an corresponding control station, in order to provide especially for track-vehicles eventually over regional information exchange.

According to the proposed arrangement of transmitter-receiver units respectively locating elements in the area of practicable rails respectively tracks enables to use elements with very low transmitting power, which assures that only vehicles on the associated track can receive a respective direction signal.

A very favourable development in the present invention is, that the locating of a vehicle, especially of a rail-vehicle is independent from each other in lengthwise direction as well as in transverse direction. Locating mistakes crosswise facing the engine therefore become negligible, respectively will be totally eliminated, whereas they essentially depend on the radiation lobe in the lengthwise direction of the tracks. Locating mistakes can be kept small by the correlative directionality of the transmitted wave, e.g. by laser. Low-cost transmitter-receiver units, provide a correlative exact locating with merely a single equipment without using complicated additional systems, which are much more expensive with increasing frequency of mistakes.

A special advantage according to invention is, that an entire break down of the whole system, like with other systems, especially with those, which base on satellite-receiver, is totally impossible, as according to invention there are autonomic units concerned, which either are installed mobile or stationary as stationary relay, in the rail-area or in main control station or collateral unit. These autonomic units together provide an automatic, individual and direct communication between other rail-vehicles, stationary relays, locating elements, control stations the like, which are in the local close zone.

Dangerous situations arise e.g. out of the variance of the security-system according to invention, which is foreseen in the vehicle, especially rail-vehicle and can e.g. be as follows:

stop of a vehicle (danger of crash with a following vehicle)

overrunning of a stop-point or signal, whereas the following danger-point is overrun

a crash with a crossing or joining vehicle,

belated reaching of an intersection or of a shunt-area

deviation of the prescribed route (other rail)

uncontrolled undocking of a freight car or similar

In order to distinguish different dangerous situations, the vehicle sends different warning signals, so that other vehicles can react accordingly, as e.g. an emergency stop in the immediate danger of crash or a decrease of the speed, etc.

Alternatively could out of the emission of a widely standardised warning signal, under consideration of the mutual position of the vehicles, adequate countermeasures could be derived and beginning.

According to a special preferred type of invention, it is proposed that the vehicle emits favourably analogue data concerning its position and identification to other vehicles, being in the local close zone and/or to control stations, so that other vehicles not only in dangerous situations in at least one local close zone are informed, but a continous mutual control respectively communication concerning the most important keydata of the single vehicles is provided.

For a further increase of security it is moreover proposed, that the vehicle receives preferably continuously information about the position and identification of the other vehicles in the local close zone and compares them with the determined data concerning the move of an indicated distance and checks them for eventual dangerous situations, what corresponds to a further preferred type according to invention, whereas a continous communication with other rail-vehicles in the local close zone is not coercive.

In order to further increase the security it is moreover favourably proposed, that it is preferably continuously controlled, if the warning systems is available and/or if the transmitter-receiver units installed in the are the practicable rail respectively trails are operating, and warning signals will be emitted when a mistake occurs and/or a stop of a vehicle is effected.

Such a check respectively control of the availability of the warning systems and a check of the operating of the transmitter-receiver units in the area of the practicable rails enables a further increase of the reliability of service of the whole system, whereas e.g. following situation of a break down of one receiving system must be distinguished.

As already mentioned, the total break down of the system according to invention is not possible. A possible defect may arise either in one part of the system, which is located in the vehicle or at a locating element or a stationary relay. In all cases can in the above mentioned single-units of the security systems according to invention a self controlling-system, connected with an own sender and/or audio-optic signals be installed. This self controlling-system sends in case of a defect e.g. encoded warning signals to vehicles, especially rail-vehicles, stationary relays and/or control stations being in the local close zone, which identificate and indicate the occurred interruption.

Beside such a check-up of the availability of the warning systems, also the transmitter-receiver units being installed in the area of the practicable rails respectively tracks, must regularly be controled and checked, if they are operating, whereas in this connection if a mistake at a transmitter-receiver unit occurs, e.g. a message to the control station can be sent. In case that several vehicles each deliver a mistake or a defect of a special transmitter-receiver element, it is sure, that this transmitter-receiver unit is defect, so that a repair of the defect has to be occasioned. Furthermore it can be necessary to reduce the speed by braking of a vehicle to avoid potential accidents, with a break down of one at a special position provided transmitter-receiver-unit.

For another check-up of the system and a comparison of existing data with the determined route, a further preferred type is according to invention foreseen, that a accumulation at least of the data of the preceding transmitter-sender unit is provided and these data together with the vehicle's identification data are given up with the emission of a warning signal. In this context, e.g. changes of the schedule, carried out through a control station can be considered and if necessary, confirmed. In connection with such a self controlling of the availability of the warning systems and a check-up of the operability of the single transmitter-receiver units, especially at special positions, respective redundant systems, which can control itself, can eventually also be provided.

For an orderly and exact localisation of the position of the transmitter-receiver-units, provided in the area of practicable tracks respectively rails, it is further proposed according to invention, that the transmitter-receiver units, installed in the area of the practicable rails, are furnished with a encoding, e.g. with geographic coordinates, whereas beside geographic coordinates, e.g. additional identification marks can be conducted. Such a definite identification of transmitter-sender units in the area of the practicable rails permits also for rail-vehicles the construction of an overregional/intemational system with respective encoding of the rails and tracks in a overregional area.

A encoding respectively control of the transmitter-receiver units of the in the area of the rails provided units can also be carried out e.g. by laser and therefore immediately a check-up can be done, without a further communication between the units in the area of the rails and the units in the vehicles.

In order to assure a reliable communication respectively transfer of data between different systems of vehicles, especially within the international traffic, a further preferred type according to invention is proposed in this way, that warning signals preferably are transferred by international signal- and warning frequencies.

Beside the above discussed procedure according to invention for the locating respectively monitoring of the position of at least one vehicle and for the emission of warning signals, a system to solve the mentioned above tasks is moreover proposed. This system for the automatic locating respectively monitoring of the position of at least one track guided vehicle, especially rail-vehicle, and for the emission of warning signals, whereas there is at least one unit for locating and monitoring of the position under assistance of a sender-unit respectively combined transmitter-receiver-units, which are installed in the area of the travelling on tracks respectively rails and for the comparison of determined respectively previously given data with data concerning an indicated distance to be moved. Furthermore it is foreseen, that a unit for emission and for receiving of warning signals at least to other vehicles, being in the local zone, especially to those, which drive on another distance than the immediate driving on route, merely when dangerous situations occur.

The system according to invention succeed a reliable control of a vehicle's route, especially of rail-vehicle, and as well as a comparison with determined parameter of a indicated distance as well as also in case of occurrence respectively identification of dangerous situations at least the immediate emission of warning signals to other vehicles and eventually additional to control stations, being in the local close zone.

According to a special preferred type of invention it is proposed in this connection, that the equipment, installed in the area of the rails respectively tracks, build at least a unit for emission of a signal respectively encoding, which shows the position of the unit, e.g. of geographical coordinates, whereas a simple control of the position of a vehicle while driving on a route is provided, whereas in this connection moreover it is proposed, that a unit for receiving and registering of a vehicle's keydata is additionally foreseen.

According to another preferred type of the invention it is proposed, that in the vehicle, units for locating and monitoring the position as well in the front area, especially in the locomotive or in another actuation element, as well as in the rear area, especially in the last freight car, are foreseen, whereas especially with long vehicles, e.g. freight trains, which eventually drive rather slowly, the required time for the driving on a determined route-section can be considered and at the same time it can be controlled if the whole train is complete.

Beside the check-up of the completion of the train respectively vehicle, it is possible to reach e.g. by overrunning of shunts/turnouts a higher control and security, as well for the beginning and as for the end of a rail-vehicle, the correct driving on a shunt/turnout can be controlled. It is hereby preferable, to use control means, with which the front end of a vehicle corresponds to a closed circuit condition and the aft end to a turn out- modus, so that always it is assured, that a vehicle e.g. had completely left a crossing, before the freeing of the route is carried out.

Because of the automatic control it is possible to make a respective contact between the system in single vehicles or also to recognise, if a vehicle is not equipped with the system according to invention.

For a automatic and simplified control and controlling means it is moreover foreseen, that the units for locating and monitoring the position in a vehicle, for comparison with data and for emission concerning the route and receiving of warning signals, connected with a common control- and computer-unit or preferably integrated in this unit, as this corresponds to a further preferred type according to invention.

For an automatic control respectively possibility to avoid accidental situations with locating of potential dangerous situations, it is furthermore proposed according to invention, that the equipment for emission and receiving of warning signals is coupleable with driving equipment of the vehicle and by occurrence of dangerous situations, a influence of driving parameters of the vehicle, e.g. a reduction of the speed by braking, is feasible, so that e.g. by locating of dangerous situations through influencing the drive-parameter, e.g. through a reduction of the speed by braking, accidental situations can be selfinstructed and automatically be avoided without delays, whereas such a delays would be caused by e.g. not automatic communication systems.

As above suggested, it will be achieved in the range of the procedure according to invention as well as the system according to invention, with simple transmitter-receiver-units with low power, whereas in this connection according to a further preferable type of the invention it is proposed, that the in the area of the tracks respectively rails provided units include transponder and/or emission-units for a laser mark. for a simple transfer of the signals respectively warning signals it is proposed according to a preferred type of invention, that the transfer of signals, especially warning signals, is carried out via radiotelegraphy or cable-connections, especially glass fiber cable respectively via the rails.

In order to check-up respectively control concerning the operating respectively the availability of the systems according to invention, it is proposed according to a further preferred type of invention, that at respectively in the vehicle additional indicators, especially traffic light equipment, for indicating the operability of the system, are foreseen. In this way, especially a visual control concerning the readiness for service of the system is possible, whereas e.g. respective traffic signals as well outside at the rail-vehicle a control by passing by rail station/railroad depot and as also in the freight cars can be a moderation for the passengers.

The invention is explained in the following by the enclosed pictures showing the diagrammatic viewed examples of the system according to invention for carrying out the procedure according to invention.

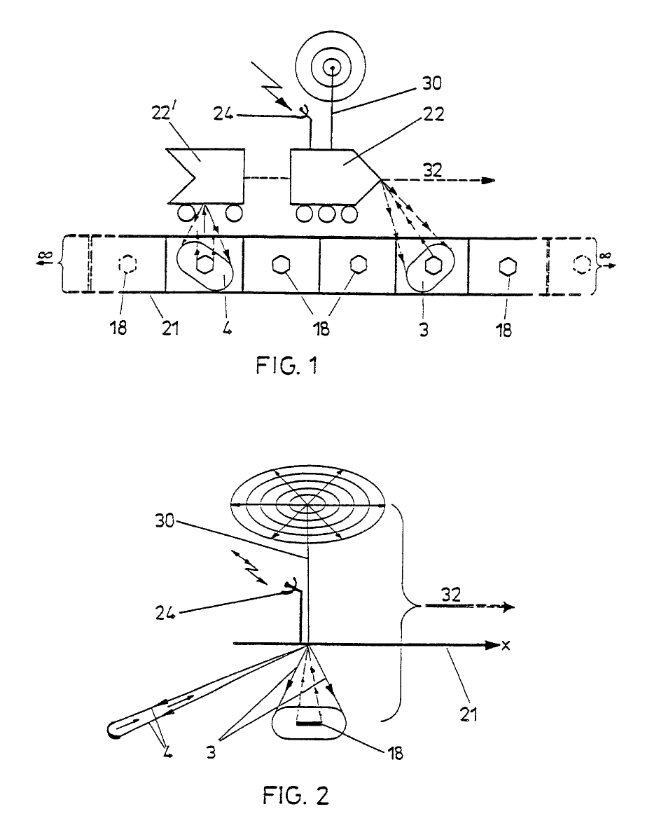

FIG. 1 A diagrammatic view of a system according to invention for locating respectively monitoring the position of at least one vehicle, especially of a rail-vehicle, for carrying out the system according to invention;

FIG. 2 A diagrammatic view of the different signal- respectively wireless-elements;

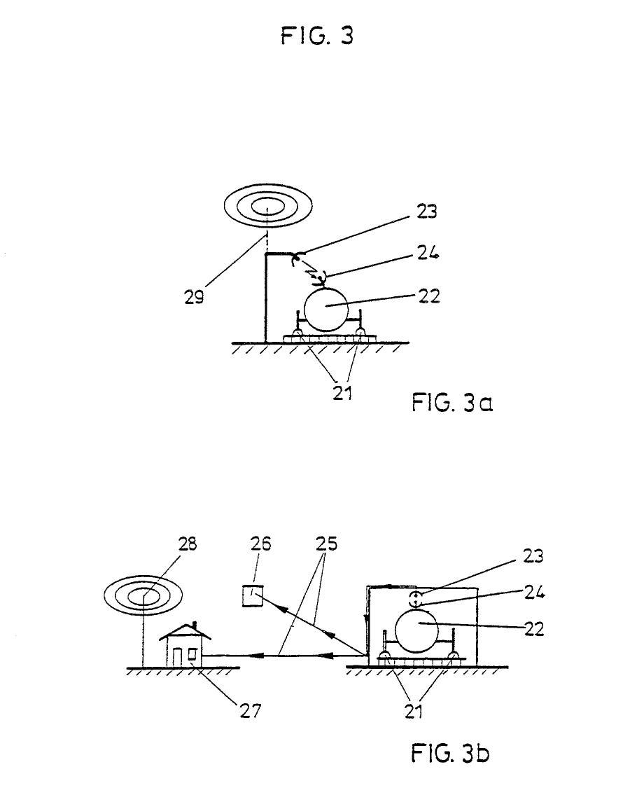

FIG. 3 Schematic the possibilities of a vehicle's connection with transmitter-receiver-units respectively of a higher control-station;

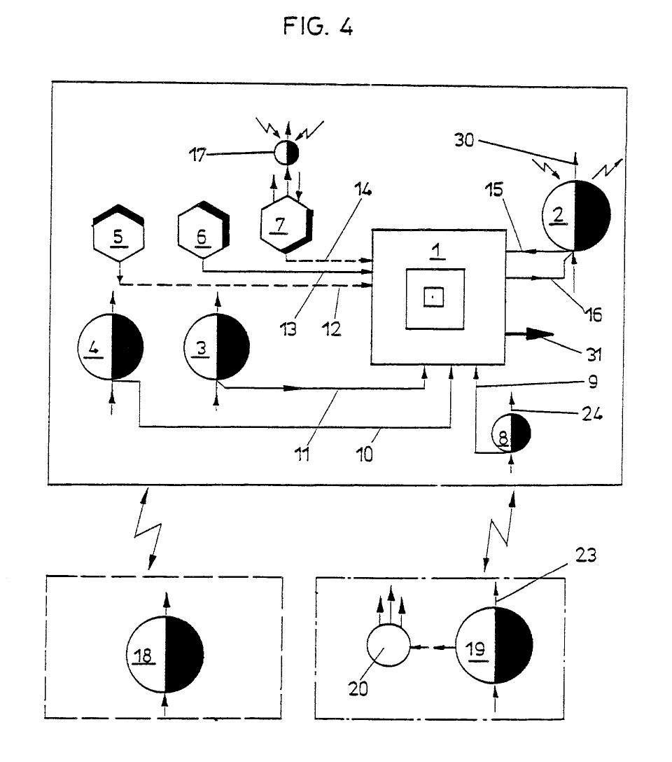

FIG. 4 A block-diagram for a system according to invention for locating respectively monitoring the position of at least one vehicle and for emission of warning signals for carrying out the procedure according to invention with further poke-home transmitter-receiver-units; and

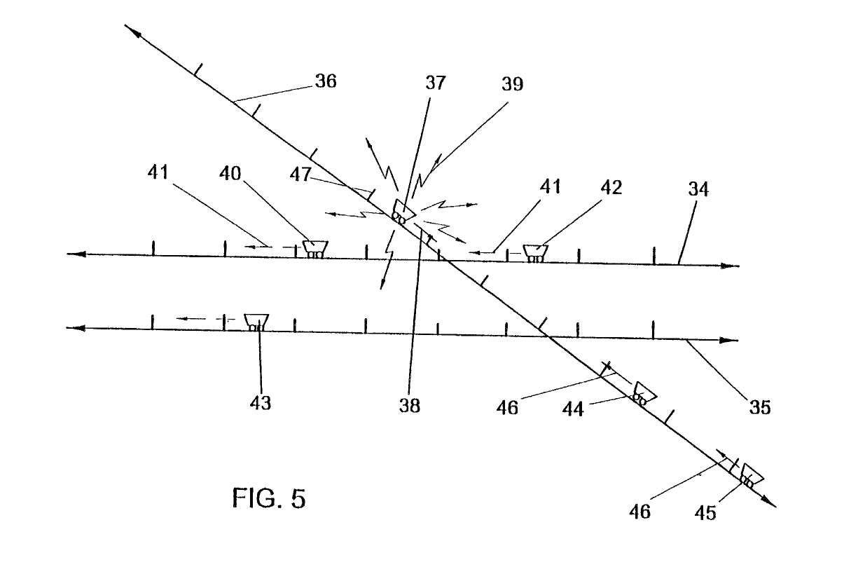

FIG. 5 a diagrammatic view of a transfer of signals between vehicles, especially rail-vehicles.

With the system for locating and monitoring the position of at least one track-guided vehicle, especially of a rail-vehicle, and for emission of warning signals it succeeds an early emission of warning signals and to avoid accidents through a direct communication between vehicles being in an immediate local close zone with the help of direct connections under use of especially international alarm- or warning-frequencies.

The following description refers to a type of realisation in connection with rail-vehicles. Alternatively the vehicles can be constituted e.g. of self-driving respectively automatic prosecuted vehicles, which drive an along determined tracks respectively railroads, whereas leading tracks are developed e.g. in a ground area, which emit electromagnetic rays for leading or guiding of such vehicles. In this way such a tracks respectively guiding rail-roads replace the rails of a rail-vehicle.

In this connection a locomotive is named with 22, in FIG. 1, which drives on a schematic with 21 marked distance, whereas in the distance, e.g. between the stretch of rails and the rail road ties an amount of transmitters 18 is provided, which will be explained in detail in the following.

In the locomotive 22 there are respective receiver- and eventually transmitter-units integrated, which under reference to FIG. 4 will be discussed in detail. Further there is also in with 22′ marked, the last segment respectively last wagon of the train a receiver-unit provided, so that especially with long trains the necessary time for the passage of trains of a distance can be considered and eventually the completion of the train respectively the proper passing over of the turnout can be controlled.

Through the comparison of the determined data, emitted by the transmitters 18 and from the respective receiver-units as in the locomotive 22 and as well eventually in the last wagon 22′ provided signal-receiver-units concerning the distance to be travelled on it succeeds a simple control of a proper traffic, whereas in occurrence of dangerous situations respectively differences from the determined data an emission of signals is made possible, as this will be discussed in the following figures in detail. In this connection in FIG. 1 with 30 the emission of warning signals is schematically implied, whereas 24 implies a receiver-antenna.

The reference-marks for the same components in FIGS. 2 and 3 are the same like in the preceding figure. The element 24 marks a receiver-unit at a trail-vehicle marked as 22, which is driving on the distance 21 e.g. in the direction of the arrow 32. In FIG. 3b there is further implied a control-station 27 and an additional receiver-unit 26.

In the block-diagram according FIG. 4 the processing and emission of respective control-signals with the driving on of a distance is herein especially detailed implied. In FIG. 4 there is an arithmetic unit respectively control-unit marked with 1, whereas signals are transmitted via lines 10, 11 from the duplex-units 3, 4 to the control-station 1. The duplex-units 3, 4 are connected to the transmitter-units 18, which are integrated in the distance. Further signals of a duplex-unit 8 are transmitted via a control line 9 to a arithmetic unit 1, whereas the duplex-unit 8 is connected with a duplex-unit 19. The marks 5, 6 and 7 in FIG. 4 are naming schematic determined data concerning the distance to be driven on, which are provided via the control lines 12, 13 and 14 to the arithmetic unit 1. Hereby 5 is e.g. a timing pulse generator, 6 is e.g. an electronic map, in which a rail net with respective geographic data and the position of the single transmitter-units 18 are shown, as they are integrated in the distance, while 7 marks a detailed plan of the distance to be driven on, which is coupleable with another transmitter-receiver-unit 17. According to a comparison of the real position-data, provided by units 3 and 4, with those provided by 5, 6 and 7 to the arithmetic unit, the compatibility of the driven distance of trail-vehicle 22 with the determined and pre-stored data can immediately be ascertained. The units 18, 19 which have to be provided in the distance can be protected from interferences and eventually removable, e.g. created like a black-box. Furthermore respective encoding for the distance, the position of the transmitter-units 18 and such like, can be foreseen.

The transmitter 19 furthermore has an additional function in FIG. 4. It controls, if the driving past rail-vehicle consists of a security system according to invention and if it is functioning. A vehicle without a security-system or a vehicle, which's security system is not working, is defined as “problem-vehicle”. In order to recognise “problem-vehicles”, it is necessary to install at the beginning of the distance, which is equipped with locating elements according to the security system of the invention at stationary points of danger, e.g. after the last turnout of a railway station, before and after turnouts, crossings and/or others, grade crossings, etc., a “registration-system” (FIG. 4, transmitter 19 and 20), in order to recognise a “problem-train” and to emit warning signals in case of necessity, what is working like that: If the transmitter 19 (only for question and answer from the train) does not receive an answer to his encoded, transmitted signals from the driving past rail-vehicle, it recognises that as a “problem-train” and induces the activity of the transmitter 20, which sends encoded warning signals via wireless and/or communication-cable e.g. to trains in the local zone, stationary relays and main- and/or side-control stations. The transmitter 19 can also induce the activity of visual and acoustic signals. The transmitter 19 can be activated through a driving past rail-vehicle, e.g. via a commonly known magnetic-relay, magnetic-rail-contact, wheel-sensor and alike. Because of this activity the transmitter 19 sends a signal via antenna 23 to the driving past rail-vehicle, whereas it, if it does in case not receive an answer from of the driving past rail-vehicle to these encoded, transmitted signals, recognises this vehicle as a “problem-train”, which either is not equipped with a security system or consists of one that does not operate. Furthermore is with 2 in FIG. 4 a duplex-receiver unit implied, with which respective information of other rail-vehicles being in a local close zone are received respectively through which data of the rail-vehicle from the arithmetic unit 1 to other rail-vehicles being in a local close zone can be transmitted, whereas signal lines are implied with 15 and 16. Comparing the provided data through the duplex-unit 3 and 4 with the determined data 5, 6 and 7 and those of others rail-vehicles received data via the unit 2, immediate statements about eventual possible dangerous situations, whereas by occurrence of such dangerous situations respective warning signals, as implied through 31, can be emitted. Furthermore can through the unit 1 while receiving signals marking a dangerous situation immediate e.g. the actuation of the rail-vehicle be influenced, so that automatically a reduce the speed by breaking can be carried out.

The transmitter-units 18 respectively 19, which are integrated in the distance, can hereby contain beside the exact position also a respective encoding, in order to enable the simplified control of the position of a rail-vehicle. In FIG. 4 there is hereby additionally implied, that beside the unit 19 also a transmitter 20 can be foreseen, which by recognising problems in connection with a driving past rail-vehicle immediate via the antenna 23, which also in FIG. 3b is schematically implied, enabling a notification respectively release of an alarm to a control station or a transmitter 26 respectively 27, whereas transmitter 20 emits respective warning signals.

In this connection it can be recognised, if a rail-vehicle is not equipped with such a system respectively if a break down of the system happened. Beside wireless signals it is also possible to transfer signals via cable or to emit visual signals, if a wireless communication, as e.g. in a tunnel, beside military check points or airports, is not easily respectively not possible at all or light signals supporting are implanted.

The system according to invention hereby can integrated without further problems in already existing rail nets and rail-vehicles with low costs and simply under use of already known transmitter-receiver-units, whereas especially through the implementation of international alarm- or warning frequencies also a simple modulation between train systems eventually from different countries can be enabled. Hereby it needs merely very small building instruments with low consumption of electric energy, which eventually can be operating for the in the distance integrated elements with solar cells or long-term batteries, whereas under warranty of effective output and long functional duration an independence of an external supply of energy, e.g. via electric lines, is enabled. As respective duplex-units are integrated in stationary relays respectively transmitter-units, the assembly and application will be furthermore simplified.

The system according to invention and especially the transmitter-receiver-unit implied in FIG. 4, to be arranged in a rail-vehicle, which via the single piece parts essentially take the control, can eventually be foreseen also in a portable unit, so that rail-vehicles either can be easily backfitted or can e.g. in the transnational traffic be easily implanted into rail-vehicles, which are not yet equipped with the system according to invention, in order to enable a respective communication with other rail-vehicles under a standardized system.

Furthermore it is possible to transfer the signals with already known equipment in a reliable way either in form of merely warning signals or a continuous transfer of data of the single rail-vehicles to further rail-vehicles being in a local close zone or additionally to higher ranking control stations.

In FIG. 5 there is a schematic crossing-situation at several trails 34, 35 and 36, whereas the trails 34 and 35 are parallel and cross a trail 36. Such a crossing marks for the system according to invention a stationary dangerous point, which has to be controlled respectively to be recognized, at which e.g. at least two rail-vehicles can meet one against the other. Other stationary dangerous points are e.g. rail road crossings with streets or other grade crossings. Opposite to that variable dangerous points are situations, whereas e.g. a rail-vehicle eventually because of a mistake or break down stands still or overrides a stop-point or a signal, so that a collision with following or previous rail-vehicles is possible. The single rail-vehicles must be able to recognize, if the coming in warning signal of one rail-vehicle in the nearby is relevant for the continuation of the train ride or if e.g. for the reason that the rail-vehicle had already passed a dangerous point, no reaction is necessary.

In the connection with the control of stationary dangerous points can a control of grade crossings e.g. be carried our in this way of an area-monitoring or a monitoring of such a grad crossing with light-barriers, inductive loops or weighing equipment, so that e.g. a hanging up vehicle, which had not yet entirely left a track, can be detected and in this way through the emission of respective signals via the in the track-area implanted transmitter/receiver-units enable respective counter measures against other coming close rail-vehicles similar to a already-known automatic control while coming close to an automatic shutting gate installation. If a road-vehicle stands still on a railway-crossing, consequently it is possible, to send a warning signal to rail-vehicles entering the close zone, e.g. through the implementation of a speed-depending activation of a safeguarding plant of a railway-crossing. Also the speed-depending self-instructed operation, whereas the vehicle at the signal box self-instructed releases the adjustment of the train track, would be possible, whereby results a big relief of routine work for the operator of the safeguarding plant.

As it is shown in FIG. 5, the schematic implied rail-vehicle 37, which moves in direction of the arrow 38, emits warning signals, as implied through the arrows 39. For a rail-vehicle 40, which moves in direction of the arrows 41, the received warning signals are not relevant any more, as the rail-vehicle 40 had already passed the crossing between the rails 34 and 36. Opposite to that the emitted warning signals of the rail-vehicle 37 are relevant for a further rail-vehicle 42, which also is moving in direction of the arrow 41, in order to avoid a collision in the area of the intersection between the rails 34 and 36. In case that another rail-vehicle 43 on the track 35 can also receive the warning signals, so are these warning signals also for this rail-vehicle not relevant anymore. Opposite there are however, for the other rail-vehicles 44 and 45, which come closer to rail-vehicle 37 corresponding to arrow 46, also these warning signals relevant, so that either an immediate reducing the speed by braking of all vehicles must be carried out or at least it must be attempted, that the vehicles 44 and 45 e.g. can resort to track 35 via respective turnouts, being described not detailed.

In the area of the tracks respectively rails 34, 35 and 36 respective transmitter/receiver-units are hereby implanted in regular space for monitoring the position, whereas one of these transmitter/receiver-units is marked with 47. These transmitter/receiver-units 47 can hereby consist of, beside the geographic co-ordinates, additional data about a special track and such like, whereas with respective overregional numbering of the track plants also e.g. transnational systems can be constructed.

A later adjustment respectively change of schedules respectively of set values, especially in the rail-vehicles, is simple and easy to be accomplished, e.g. from main- and/or side control stations, through the already known methods of wireless via the transmitting of encoded signals to the system part according to invention integrated in the rail-vehicle, in order to carry out the desired adjustment or change automatically, whereas the main- and/or side control stations must receive a back-confirmed answer from the system (automatic transfer of a change). It is additionally possible, that the locomotive driver receives e.g. by wireless an order to change, whereas arrangements must be made to avoid misunderstandings. The permit of such a change can only be enabled by use of a solemnly used password, that he received from a main- and/or side control station by wireless, internet and/or such like. The locomotive driver must confirm the received information through an immediate back-message to the main- and/or side control station, preferably written, e.g. via internet, or also orally, in order to avoid any kind of misunderstanding and therefore guarantee the security.

If a further rail-vehicle stands still and does not drive on for longer time respectively is not permitted to continue the journey, it emits warning signals, in order to inform eventually following rail-vehicles from the unchanged stop.

It is a further advantage of the system, that the present position of a rail-vehicle while driving on its route can be identified on a switchboard in the station management or on a monitor, and not only, as presently usual, e.g. by wireless between rail-vehicle, rail-way stations and control stations. Such a locating can without any contact by wireless or without the use of communications elements and in this way without deviation of the locomotive driver be carried out, that means, if no warning message is received of the rail-vehicle, that a train systematically and without any interruption had passed his route respectively is on its way between locating points being defined as set locating points.

Similar to the above described types of performance for rail-vehicles respective risky respectively dangerous situations are in general possible for track-guided vehicles, as also with such track-guided vehicles crossings with similar constructions result, where a coming closer of moving vehicles at the same time or a collision between those must avoided in a reliable way.

### Summary

With a procedure and a system for the automatic monitoring and controlling of the position of at least one track-guided vehicle (22), especially of a rail-vehicle, and for emitting of warning signals, whereby in the vehicle, preferable continuously the position of the vehicle (22) is monitored and controlled under use of transmitter/receiver units (18, 19) being implanted in the area of the travelling on tracks respectively rails (21) and compared with determined respectively previous given data, which refer to the distance to be travelled on, it is foreseen, that by occurrence of dangerous situations from the vehicle (22) warning signals at least to other vehicles (22), being in the local close zone, especially to vehicles (22), which are travelling on a different way than the immediate travelled on way, are emitted, in order to yield an increase of the reliability and the security of fall-outs.

1. System for automatically monitoring respectively controlling of the position of at least one track-guided vehicle (22, 37, 40, 42, 43, 44, 45), especially rail-vehicle, and for the emission of warning signals, whereas in the vehicle preferably continues the position of the vehicle (22, 37, 40, 42, 43, 44, 45) under use of transmitter/receiver-units (18, 19, 47) being provided in the area of the travelling over tracks respectively rails (21, 34, 35, 36) and for comparison with the determined respectively previously given data, referring to the route to be travelled on, is characterized that way, that by occurrence of dangerous situations, the vehicle (22, 37, 40, 42, 43, 44, 45) sends warning signals at least to other vehicles (22, 37, 40, 42, 43, 44, 45) being in the local close zone, especially to those, which are travelling on a different way from the immediate passing over way.

2. System according to patent claim 1, is characterized that way, that from a vehicle (22, 37, 40, 42, 43, 44, 45) different warning signals corresponding to different dangerous situations are emitted.

3. System according to patent claim 1 or 2, characterized that way, that from the vehicle (22, 37, 40, 42, 42, 44, 45) furthermore preferably continuous data concerning the position and identification to other vehicles (22, 37, 40, 42, 43, 44, 45) being in the local close zone, and/or to control stations are transmitted.

4. System according to patent claim 1, 2 or 3, characterized that way, that the vehicle (22, 37, 40, 42, 43, 44, 45) receives preferably continuous from other vehicles (22, 37, 40, 42, 43, 44, 45) in the local close zone, data concerning the position and identification of these vehicles (22, 37, 40, 42, 43, 44, 45) and compares them with those determined and previously given data concerning the distance to be travelling on and checks if there are possible dangerous situations.

5. System according to one of the patent claims 1 to 4, characterized that way, that preferably continuous a check-up of the availability of the warning systems and/or a check-up of the functionality of the transmitter-receiver units (18, 19, 47) implanted in the area of the travelling on tracks respectively rails (21, 34, 35, 36) is carried out and that by occurrence of a mistake, warning signals are emitted and/or a stop of the vehicle (22, 37, 40, 42, 43, 44, 45) is effected.

6. A system according to one of the patent claims 1 to 5, characterized in that way, that the transmitter-receiver units (18, 19, 47), which are implanted in the area of the travelling on tracks respectively rails (21, 34, 35, 36) are equipped with an encoding, e.g. geographic co-ordinates.

7. A system according to one of the patent claims 1 to 6, characterized in that way, that a storage at least of the data of the previous transmitter-receiver units is carried out, and these data together with identification-data of the vehicle (22, 37, 40, 42, 43, 44, 45) are emitted with the emission of warning signals.

8. A system according to one of the patent claims 1 to 7, characterized in that way that warning signals are transferred via preferably internationals alarm- or warning frequencies.

9. A system for the automatic monitoring and controlling of the position of at least one track-guided vehicle, especially rail-vehicle and for the emission of warning signals, whereas the vehicle (22, 37, 40, 42, 43, 44, 45) consists of at least one unit (2) for the monitoring and controlling of the position under use of transmitter-receiver units (18, 19, 47) which are integrated in the area of the travelling on tracks respectively rails (21, 34, 35, 36) and for comparison with the determined respectively previously given data referring to the way to be travelled on, characterized in this way, that furthermore a unit (2) is foreseen for emission and receiving of warning signals at least to other vehicles (22, 37, 40, 42, 42, 44, 45) being in the local close zone, especially to those travelling on another way than the way immediate passing over by occurrence of dangerous situations.

10. A system according to patent claim 9, characterized in that way, that the units (18, 19) implanted in the area of the rails respectively tracks (21, 34, 35, 36) at least consist of one unit for emission of a signal that marks the position of the unit respectively an encoding, e.g. of geographic co-ordinates.

11. A system according to patent claim 9 or 10, characterized in that way, that additionally a unit for receiving and storage of keydata of the vehicle (22, 37, 40, 42, 43, 44, 45) is foreseen.

12. A system according to patent claim 9, 10 or 11, characterized in that way, that units are foreseen for the monitoring and controlling the position as well in the front area (22), especially in the locomotive or a driving element, as also in the back side (22′), especially at the last wagon.

13. A system according to one of the patent claims 9 to 12, characterized in that way, that in the vehicle (22, 37, 40, 42, 43, 44, 45) the units (2, 3, 4, 8) for the monitoring and controlling the position, for comparison with data referring to the distance and for emitting and for receiving of warning signals are coupled with a common control-and arithmetic unit (1) or preferably are integrated in this one.

14. A system according to one of the patent claims 9 to 13, characterized in that way, that the unit (2) for emission and for receiving of warning signals is coupleable with driving units of the vehicle (22, 37, 40, 42, 43, 44, 45) and by occurrence of dangerous situations an influence of driving parameters of the vehicle, e.g. a reducing the speed by braking, is feasible.

15. A system according to one of the patent claims 9 to 14 characterized in that way, that the units (18, 19, 47) implanted in the area of the tracks respectively rails (21, 34, 35, 36) consist of transponder and/or units for a laser marking.

16. A system according to one of the patent claims 9 to 15, characterized in that way, that the transfer of signals, especially warning signals, is carried out via wireless or cable connection, especially a glass fibre cable, respectively via the rail (21).

17. A system according to one of the patent claims 9 to 16, characterized in that way, that at respectively in the vehicle (22, 37, 40, 42, 42, 43, 44, 45) additional displays, are foreseen, especially light signals units, for the displaying of the functionalibility of the system.
